(19) United States
(12) Patent Application Publication
(10) Pub. No.: US 2007/0216065 A1
(43) Pub. Date: Sep. 20, 2007

(54) Method for filling polymer materials into a hot-mold for manufacturing a multizone polymer blank

(75) Inventor: Sheng-Tzu Hsu, Taipei City (TW)

Correspondence Address: TROXELL LAW OFFICE PLLC, SUITE 1404, 5205 LEESBURG PIKE, FALLS CHURCH, VA, 22041, US

(73) Assignee: King Steel Machinery Co., Ltd.

(21) Appl. No.: 11/402,044

(22) Filed: Apr. 12, 2006

(30) Foreign Application Priority Data
Mar. 14, 2006 (TW) 095108558

(51) Int. Cl. B29C 43/02

(52) U.S. Cl. 264/319

(57) ABSTRACT

A method for filling polymer materials into a hot-mold for manufacturing a multizone polymer blank. At least one partitioning section is positioned in the blank mold cavity of a mold to partition the blank mold cavity into at least two independent compartments not communicating with each other. Different polymer materials are respectively filled into the corresponding independent compartments. After the filling of the materials is completed, the partitioning section is removed or the partitioning section is combined with the filled materials to form a multizone blank.

### BACKGROUND OF THE INVENTION

The present invention is related to a polymer material-molding technique, and more particularly to a method for filling polymer materials into a hot-mold for manufacturing a multizone polymer blank.

In the conventional hot-mold injection molding technique, the mold is kept at a temperature slightly lower than the polymerization or coupling reaction temperature of polymer materials. After the materials are injected, the time for the temperature of the materials to rise to the reaction temperature is shortened to enhance the manufacturing efficiency.

According to the above conventional technique, the mold is kept at a considerably high temperature. Therefore, the molten polymer material injected into the mold by the injection apparatus has considerable flowability in the mold cavity. Such flowability will cause no harm to single-color material injected into the mold cavity and molded into a blank. However, with respect to double-color or multicolor or double-density or multi-density blank, such flowability of the materials makes it impossible to manufacture the blank.

To speak more detailedly, with a polymer material previously filled in the mold cavity, when another polymer material is injected into the mold cavity with one single nozzle, due to the double effects of the high temperature of the mold and the high temperature of the other polymer material, the later injected polymer material will shift the surface of the previously injected polymer material. Consequently, the interface between the two materials will be unclear and thus the two materials can be hardly truly distinguished from each other. The colors will be mixed or shifted into an uneven state. With respect to the multi-density blank, the densities will be undistinguishable.

In the case that two different polymer materials are respectively injected into the mold cavity with double nozzles, the flow of the two materials is still uncontrollable. Accordingly, without being controlled, the materials will be doped with each other. Consequently, it is impossible to manufacture the multicolor or multi-density polymer blank.

### SUMMARY OF THE INVENTION

It is therefore a primary object of the present invention to provide a method for filling polymer materials into a hot-mold for manufacturing a multizone polymer blank. By means of this method, when different polymer materials are filled into the mold cavity of a hot mold, the polymer materials can keep a suitable flowability without being doped with each other. Therefore, the quality of the multizone blank can be ensured and the manufacturing efficiency is enhanced.

It is a further object of the present invention to provide the above method for filling polymer materials into the hot-mold for manufacturing the multizone polymer blank. In this method, the different polymer materials are filled into the same mold cavity at the same time with multiple injection nozzles. The different polymer materials are respectively kept in specific portions of the mold cavity without being doped with each other.

According to the above objects, the method of the present invention includes steps of: positioning at least one partitioning section in the blank mold cavity of a mold to partition the blank mold cavity into at least two independent compartments not communicating with each other; respectively filling different polymer materials into the corresponding independent compartments; and after the filling of the materials is completed, removing the partitioning section or combining the partitioning section with the filled materials to form a multizone blank.

The present invention can be best understood through the following description and accompanying drawings wherein:

### BRIEF DESCRIPTION OF THE DRAWINGS

FIG. 1 is a flow chart of a first embodiment of the present invention;

FIG. 2 is a sectional view of the mold of the first embodiment of the present invention;

FIG. 3 is a flow chart of a second embodiment of the present invention;

FIG. 4 is a sectional view of the mold of the second embodiment of the present invention;

FIG. 5 is a flow chart of a third embodiment of the present invention; and

FIG. 6 is a sectional view of the mold of the third embodiment of the present invention.

### DETAILED DESCRIPTION OF THE PREFERRED EMBODIMENTS

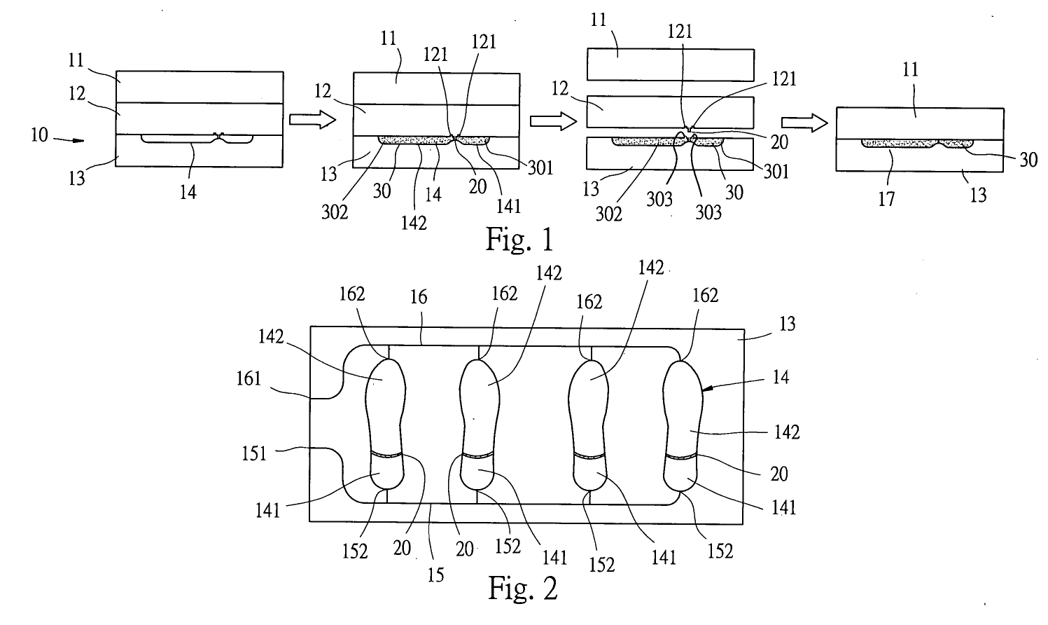

Please refer to FIGS. 1 and 2. According to a first embodiment, the method for filling polymer materials into a hot-mold for manufacturing a multizone polymer blank of the present invention includes steps of:
a. preparing a mold 10 kept within a predetermined range of temperature, the mold 10 being composed of a first mold section 11, a second mold section 12 and a third mold section 13 which are piled up, the second and third mold sections 12, 13 defining therebetween an internal blank mold cavity 14, the mold 10 being formed with a first flow way 15 and a second flow way 16 communicating with different portions of the blank mold cavity 14 with outer side of the mold 10, the first and second flow ways 15 respectively having a first material-filling port 151 and a second material-filling port 161 on a surface of the mold 10, also, the first and second flow ways 15 respectively having a first material inlet 152 and a second material inlet 162 on a wall of the blank mold cavity 14, a partitioning plate section 20 being positioned in the blank mold cavity 14, whereby when the mold sections are mated, the partitioning plate section 20 partitions the mold cavity 14 into two independent compartments 141, 142 not communicating with each other, the first and second compartments 141, 142 communicating with the flow ways 15, 16 via the first and second material inlets 152, 162, the partitioning plate section 20 downward extending from a bottom face of the second mold section 12 by a predetermined length, whereby when the when the second and third mold sections 12, 13 are mated and attached to each other, the partitioning plate section 20 extends into the blank mold cavity 14 to partitions the blank mold cavity 14 into two independent compartments 141, 142, the bottom face of the second mold section 12 being further formed with two grooves 121 on two sides of the partitioning plate section 20, the total capacity of the two grooves 121, 122 being equal to the volume of the partitioning plate section 20, when the second and third mold sections 12, 13 are mated, the two grooves 121, 122 serving as a part of the blank mold cavity 14;
b. mating the second and third mold sections 12, 13 with each other, whereby the compartments 141, 142 of the blank mold cavity 14 can only communicate with outer side via the corresponding flow ways 15, 16;
c. respectively filling different polymer materials with different nozzles through the first and second flow ways 15, 16 into the first and second compartments 141, 142, the partitioning plate section 20 serving to isolate the different polymer materials from each other so that the different polymer materials will not directly contact with each other;
d. opening the mold 10 after the filling of the polymer materials is completed, the filled polymer materials forming a multizone blank 30 which remains in the third mold section 13, when the second mold section 12 is separated from the third mold section 13, the partitioning plate section 20 leaving the blank 30 to leave a gap between the two compartments 141, 142, whereby the multizone blank 30 includes two separate partial blocks 301, 302 respectively corresponding to the two compartments 141, 142, the two partial blocks 301, 302 having different colors or different densities to form the multizone blank 30;
e. removing the second mold section 12;
f. mating the first mold section 11 with the third mold section 13 to define a product mold cavity 17, a bottom face of the first mold section 11 downwardly squeezing two ribs 303 formed of the filled polymer materials 30 corresponding to the two grooves 121, whereby the partial blocks 301, 302 are compressed to synchronously fill up the gap between the partial blocks 301, 302 so that the partial blocks 301, 302 can adjoin each other with a tidy interface without doping or shift of the colors or the materials; and
g. providing heat and pressure for the blank 30 to react in the product mold cavity 17 and be molded.

According to the above method, when the molten polymer materials are filled into the blank mold cavity 14 with the injection apparatus, in a hot-mold state, the polymer materials can keep a suitable flowability and the partitioning plate section 20 serves to prevent the materials from being doped with each other when filled. Therefore, the multizone blank can have a stable quality. The amount of the filled materials will not be reduced due to the existence of the partitioning plate section 20. The blank 30 is compensated with the materials in the grooves 121 to ensure a constant amount of filled materials.

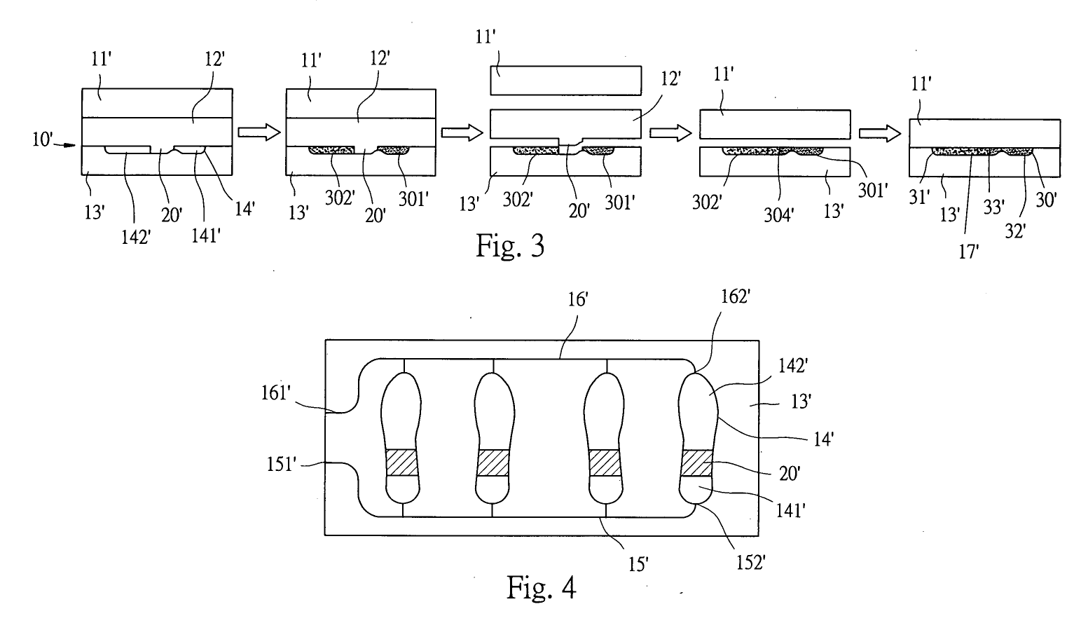

FIGS. 3 and 4 show a second embodiment of the method for filling polymer materials into the hot-mold for manufacturing the multizone polymer blank of the present invention. The second embodiment is substantially identical to the first embodiment. However, there are two differences between the first and second embodiments as follows:

First, in step a, the partitioning section 20′ is a block body with a certain size free from the grooves as in the first embodiment. Accordingly, when step d is finished, the multizone blank 30′ is not yet completed. Two partial blocks 301′, 302′ are left in the third mold section 13′ and separated from each other.

Second, accordingly, in step e, after the second mold section 12′ is removed, a multizone blank block 304′ preformed with a cold mold is filled between the partial blocks 301′, 302′. The blank block 304′ has a configuration identical to that of the partitioning section 20′, whereby the blank block 304′ and the two partial blocks 301′, 302′ together form the blank body 30′. Then, steps f and g of the first embodiment are performed to achieve the product.

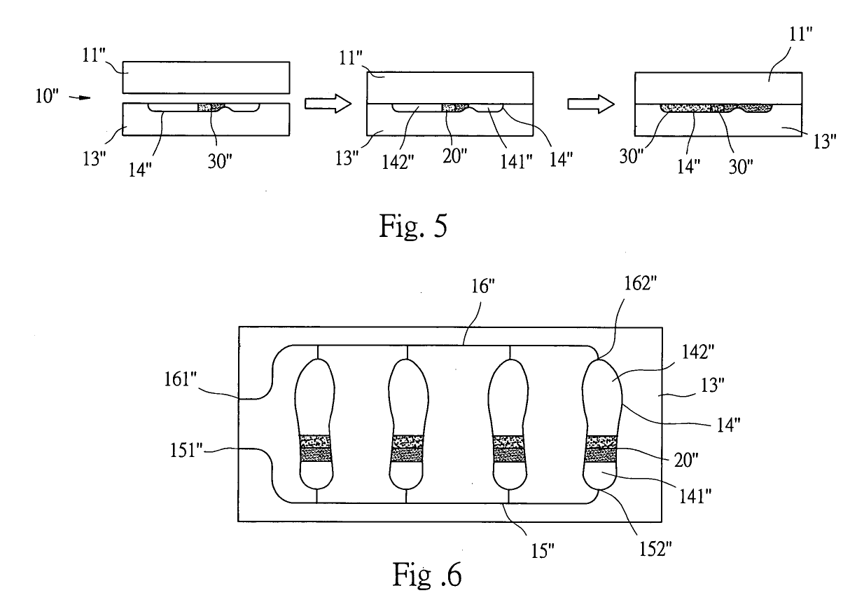

FIGS. 5 and 6 show a third embodiment of the method for filling polymer materials into the hot-mold for manufacturing the multizone polymer blank of the present invention. There are two differences between the first and third embodiments. First, in the third embodiment, the mold 10″ is simply composed of a first and a third mold sections 11″, 13″. The first and third mold sections 11″, 13″ define a mold cavity 14″ equivalent to both the blank mold cavity and the product mold cavity of the first embodiment. Second, in this embodiment, the partitioning section 20″ is actually a multizone blank block 304′ preformed with a cold mold as in the second embodiment. Accordingly, in this embodiment, in step a, with the mold 10″ opened, the partitioning section 20″ is filled into the mold cavity 14″ of the third mold section 13″ in a position where the interface of the multizone blank is positioned. Then steps b and c are performed.

In the third embodiment, the second mold section does not exist. Therefore, steps d, e and f of the first embodiment are omitted in the third embodiment.

The above embodiments are only used to illustrate the present invention, not intended to limit the scope thereof. Many modifications of the above embodiments can be made without departing from the spirit of the present invention.

What is claimed is:

1. A method for filling polymer materials into a hot-mold for manufacturing a multizone polymer blank, comprising steps of:
a. preparing a mold kept within a predetermined range of temperature, the mold having an internal blank mold cavity, the mold being also formed with a first flow way and a second flow way communicating the blank mold cavity with outer side of the mold, the first and second flow ways respectively having a first material-filling port and a second material-filling port on a surface of the mold and respectively having a first material inlet and a second material inlet on a wall of the blank mold cavity, a partitioning section being positioned in the blank mold cavity, whereby when the mold is closed, the partitioning section partitions the blank mold cavity into a first and a second independent compartments not communicating with each other, the first and second compartments respectively communicating with the flow ways via the first and second material inlets;
b. closing the mold; and
c. respectively filling predetermined amounts of different polymer materials through the first and second flow ways into the first and second compartments.

2. The method for filling the polymer materials into the hot-mold for manufacturing the multizone polymer blank as claimed in claim 1, wherein the partitioning section is a multizone block as a part of the multizone polymer blank, the multizone block having two different zones respectively corresponding to the two compartments.

3. The method for filling the polymer materials into the hot-mold for manufacturing the multizone polymer blank as claimed in claim 2, wherein the partitioning section is preformed with a cold mold.

4. The method for filling the polymer materials into the hot-mold for manufacturing the multizone polymer blank as claimed in claim 1, wherein the partitioning section is a body with a predetermined thickness and a predetermined shape.

5. The method for filling the polymer materials into the hot-mold for manufacturing the multizone polymer blank as claimed in claim 4, wherein the mold is composed of a first mold section, a second mold section and a third mold section which are piled up, the partitioning section downward extending from a bottom face of the second mold section toward the third mold section.

6. The method for filling the polymer materials into the hot-mold for manufacturing the multizone polymer blank as claimed in claim 5, wherein in steps a to c, the blank mold cavity is defined between the second mold section and the third mold section, the method further comprising steps of:
d. opening the mold and leaving the filled polymer materials in the third mold section;
e. removing the second mold section;
f. mating the first mold section with the third mold section to define a product mold cavity therebetween; and
g. providing heat and pressure for the filled materials to react in the product mold cavity and be molded.

7. The method for filling the polymer materials into the hot-mold for manufacturing the multizone polymer blank as claimed in claim 5, wherein the bottom face of the second mold section is further formed with two grooves on two sides of the partitioning section, a total capacity of the two grooves being equal to a volume of the partitioning section, the grooves respectively communicating with the two compartments to serve as a part of the blank mold cavity.
